(19) United States
(12) Patent Application Publication
(10) Pub. No.: US 2026/0361256 A1
(43) Pub. Date: Nov. 12, 2026

(54) COMMUTATION CONTROL METHOD, SYSTEM AND NON-TRANSITORY COMPUTER-READABLE MEDIUM FOR BRUSHLESS MOTOR

(71) Applicant: JIANGSU DONGCHENG M&E TOOLS CO., LTD., Nantong, Jiangsu (CN)

(72) Inventors: Haodong Wang, Nantong, Jiangsu (CN); Shibin Guo, Nantong, Jiangsu (CN)

(21) Appl. No.: 19/489,649

(22) PCT Filed: Dec. 18, 2024
(86) PCT No.: PCT/CN2024/140211

§ 371 Date: Dec. 3, 2025

(30) Foreign Application Priority Data
Dec. 29, 2023 (CN) 202311863594.4

(51) Int. Cl. H02P 29/028; H02P 6/12; H02P 6/182; H02P 6/28; H02P 6/34

(52) U.S. Cl. CPC H02P 29/028; H02P 6/12; H02P 6/182; H02P 6/28; H02P 6/34; H02P 2207/05

(57) ABSTRACT

The present disclosure provides a commutation control method, system and non-transitory computer-readable medium for brushless motor. The commutation control method incudes: step 1: acquiring at least one of a bus current value and a commutation time interval in response to detecting a failure of a back-EMF (electromotive force) zero-crossing commutation; step 2: acquiring processing information according to at least one of the bus current value and the commutation time interval; step 3: determining whether the processing information satisfies a preset condition and controlling the motor to be forcedly commutated in response to satisfying the preset condition.

### TECHNICAL FIELD

The present disclosure belongs to the field of brushless motor control, and particularly relates to a commutation control method and system for brushless motor, and readable medium.

### BACKGROUND ART

At present, many power tools and garden tools are controlled by brushless motors without position sensors. Because no position sensor is used, the whole machine is more compact and smaller, which also saves costs and simplifies the assembly workers.

However, when using the non-inductive control method under certain working conditions, such as when the torque is insufficient, or when the load torque is too large, or when the load torque suddenly increases, it is easy to cause the motor to have a chaotic commutation state. At this time, the back-EMF (electromotive force) of the motor becomes abnormal. When the commutation control is based on the back-EMF zero-crossing, it will bring a huge error to the position judgement of the controller. And the control error will further cause the disorder of the motor operation, thus creating a vicious cycle.

Due to the disordered position, it is bound to cause an increase in current fluctuation. When the fluctuation is too large, overcurrent protection will be triggered. So, from the macroscopic perspective of the overall operation of the machine, the above process is that when the machine encounters a heavy load, it is very likely to shut down for protection, causing confusion and inconvenience to the user and resulting in a poor user experience.

As a consequence, it is necessary to design a commutation control method and system for brushless motor, and readable medium to solve the above problems.

### SUMMARY OF THE DISCLOSURE

To address the shortcomings of existing techniques, some embodiments of the present disclosure may provide a commutation control method, system and readable medium for brushless motor. This solution may resolve the problem that when a brushless motor without a position sensor may experience commutation disorder under some working conditions by implementing an error correction mechanism to restore failed detection and control. Consequently, the motor operation control may be normal, enabling smooth continued system operation, enhanced stability, and improved user experience.

The technical solution adopted by the present disclosure to solve the existing technical problems may provide a communication control method for a brushless motor.

A commutation control method for a brushless motor may include following actions or steps.

Step 1: acquiring a bus current value and/or a commutation time interval in response to detecting a failure of a back-EMF zero-crossing commutation.

Step 2: acquiring a processing information according to the bus current value and/or the commutation time interval.

Step 3: determining whether the processing information may satisfy a preset condition, and controlling the motor to be forcedly commutated in response to satisfying the preset condition.

A refined solution may be as follows: the processing information may include a bus current slope value and/or a bus current difference value and/or a bus current instantaneous value and/or a commutation time prediction value. A refined solution may be as follows: the processing information may include a bus current slope value, the processing information may include a bus current slope value, and the step 3 may include:

Controlling the motor to be forcedly commutated in response to the bus current slope value satisfying a first preset condition.

The first preset condition may be that the bus current slope value may vary in a rule of being greater than zero, substantially equal to zero, and less than zero in sequence.

A refined solution may be as follows: the processing information may include a bus current slope value, the processing information may include a bus current slope value, and the step 3 may include:

Controlling the motor to be forcedly commutated in response to the bus current difference value satisfying a second preset condition. The second preset condition may be that the bus current slope value varies in a rule of being greater than zero, substantially equal to zero, less than zero and greater than zero in sequence.

A refined solution may be as follows: the processing information may include a bus current difference value, the processing information may include a bus current difference value, and the step 3 may include:

Controlling the motor to be forcedly commutated in response to the bus current difference value satisfying a third preset condition. The third preset condition may be that the bus current difference value may vary in a rule of being greater than zero, substantially equal to zero, and less than zero in sequence.

A refined solution may be as follows: the processing information may include a bus current difference value, the processing information may include a bus current difference value, and the step 3 may include:

Controlling the motor to be forcedly commutated in response to the bus current difference value satisfying a fourth preset condition. The fourth preset condition may be that the bus current difference value may vary in a rule of being greater than zero, substantially equal to zero, less than zero and greater than zero in sequence.

A refined solution may be as follows: the processing information may include a bus current slope value, a bus current instantaneous value and a commutation time prediction value, and the step 3 may include:

Controlling the motor to be forcedly commutated in response to the bus current slope value satisfying a first preset condition and the bus current instantaneous value satisfying a threshold condition, and the commutation time prediction value satisfying a time condition.

The first preset condition may be that the bus current slope value may vary in a rule of being greater than zero, substantially equal to zero, and less than zero in sequence.

A refined solution may be as follows: the processing information may include a bus current slope value, a bus current instantaneous value and a commutation time prediction value, and the step 3 may include:

Controlling the motor to be forcedly commutated in response to the bus current slope value satisfying a second preset condition and the bus current instantaneous value satisfying a threshold condition, and the commutation time prediction value satisfying a time condition. The second preset condition may be that the bus current slope difference value may vary in a rule of being greater than zero, substantially equal to zero, less than zero and greater than zero in sequence.

A refined solution may be as follows: the processing information may include a bus current difference value, a bus current instantaneous value and a commutation time prediction value, and the step 3 may include: controlling the motor to be forcedly commutated in response to the bus current difference value satisfying a third preset condition and the bus current instantaneous value satisfying a threshold condition and the commutation time prediction value satisfying a time condition.

The third preset condition may be that the bus current difference value may vary in a rule of being greater than zero, substantially equal to zero, and less than zero in sequence.

A refined solution may be as follows: the processing information may include a bus current difference value, a bus current instantaneous value and a commutation time prediction value, and the step 3 may include: controlling the motor to be forcedly commutated in response to the bus current difference value satisfying a fourth preset condition and the bus current instantaneous value satisfying a threshold condition, and the commutation time prediction value satisfying a time condition. The fourth preset condition may be that the bus current difference value may vary in a rule of being greater than zero, substantially equal to zero, less than zero and greater than zero in sequence.

A refined solution may be: a commutation control system for a brushless motor.

The commutation control system may include: a detection module, an acquisition module, a processing module and a determination module.

The detection module may be configured to detect a back-EMF zero-crossing commutation.

The acquisition module may be configured to acquire a bus current value and/or a commutation time interval in response to the detection module failing.

The processing module may be configured to process the bus current value and/or the commutation time interval to generate processing information.

The determination module may be configured to determine whether the processing information may satisfy a preset condition and control the motor to be forcedly commutated in response to satisfying the preset condition.

A refined solution may be as follows: the processing information may include a bus current slope value and/or a bus current difference value and/or a bus current instantaneous value and/or a commutation time prediction value.

A refined solution may be as follows: the processing module in a commutation control system for a brushless motor may be used to:

Control the motor to be forcedly commutated in response to the bus current slope value satisfying a first preset condition.

Or controlling the motor to be forcedly commutated in response to the bus current slope value satisfying a second preset condition.

The first preset condition may be that the bus current slope value may vary in a rule of being greater than zero, substantially equal to zero, and less than zero in sequence.

The second preset condition may be that the bus current slope value may vary in a rule of being greater than zero, substantially equal to zero, less than zero and greater than zero in sequence.

A refined solution may be as follows: in a commutation control system for a brushless motor, the processing information may include a bus current difference value, and the processing module may be used to:

Control the motor to be forcedly commutated in response to the bus current difference value satisfying a third preset condition; or control the motor to be forcedly commutated in response to the bus current difference value satisfying a fourth preset condition.

The third preset condition may be that the bus current difference value may vary in a rule of being greater than zero, substantially equal to zero, and less than zero in sequence. The fourth preset condition may be that the bus current difference value may vary in a rule of being greater than zero, substantially equal to zero, less than zero and greater than zero in sequence.

A refined solution may be as follows: the processing information in a commutation control system for a brushless motor may include:

A bus current slope value, a bus current instantaneous value and a commutation time prediction value, and the processing module may be used to:

Control the motor to be forcedly commutated in response to the bus current slope value satisfying a first preset condition and the bus current instantaneous value satisfying a threshold condition, and the commutation time prediction value satisfying a time condition.

Or control the motor to be forcedly commutated in response to the bus current slope value satisfying a second preset condition and the bus current instantaneous value satisfying a threshold condition, and the commutation time prediction value satisfying a time condition.

The first preset condition may be that the bus current slope value may vary in a rule of being greater than zero, substantially equal to zero, and less than zero in sequence.

The second preset condition may be that the bus current slope value may vary in a rule of being greater than zero, substantially equal to zero, less than zero and greater than zero in sequence.

A refined solution may be as follows: in a commutation control system for a brushless motor, the processing information may include:

A bus current difference value, a bus current instantaneous value and a commutation time prediction value, and the processing module may be used to:

Control the motor to be forcedly commutated in response to the bus current difference value satisfying a third preset condition, the bus current instantaneous value satisfying a threshold condition and the commutation time prediction value satisfying a time condition.

Or control the motor to be forcedly commutated in response to the bus current difference value satisfying a fourth preset condition, the bus current instantaneous value satisfying a threshold condition and the commutation time prediction value satisfying a time condition.

The third preset condition may be that the bus current difference value may vary in a rule of being greater than zero, substantially equal to zero, and less than zero in sequence.

The fourth preset condition may be that the bus current difference value may vary in a rule of being greater than zero, substantially equal to zero, less than zero and greater than zero in sequence.

A refined solution may be: a commutation control system for a brushless motor may include:

An acquisition module, configured to acquire a bus current value and/or a sector time interval.

A back-EMF zero-crossing detection module, electrically connected to a main control module, and configured to detect a back-EMF zero-crossing of the motor and output a first signal to the main control module in response to the zero-crossing.

The main control module may be electrically connected to a drive module and the acquisition module respectively, and the main control module may include a signal output module. The signal output module may be configured to receive the first signal and output a commutation signal to the drive module.

The drive module may be configured to drive the motor to be commutated according to the commutation signal.

The main control module may further include a computational comparison module, a memory module and an output module.

The computational comparison module may be configured to receive the bus current value and/or the sector time interval and process them to generate processing information. The main control module may compare the processing information with a preset condition stored in the memory module.

The memory module may store a current threshold value and the preset condition.

In response to failing to receive the first signal, the main control module may determine whether the processing information may satisfy the preset condition, and trigger the output module to output the commutation signal in response to satisfying the preset condition.

A refined solution may be as follows: the processing information may include a bus current slope value and/or a bus current difference value and/or a bus current instantaneous value and/or a commutation time prediction value.

A refined solution may be as follows: the preset conditions may include:

The first preset condition may be that the bus current slope value may vary in a rule of being greater than zero, substantially equal to zero, and less than zero in sequence.

The second preset condition may be that the bus current slope value may vary in a rule of being greater than zero, substantially equal to zero, less than zero and greater than zero in sequence;

The third preset condition may be that the bus current difference value may vary in a rule of being greater than zero, substantially equal to zero, and less than zero in sequence.

The fourth preset condition may be that the bus current difference value may vary in a rule of being greater than zero, substantially equal to zero, less than zero and greater than zero in sequence.

A refined solution may be as follows: the preset conditions may include the following four preset conditions.

The first preset condition may be that the bus current slope difference value may vary in a rule of being greater than zero, substantially equal to zero, and less than zero in sequence. The second preset condition may be that the bus current slope difference value may vary in a rule of being greater than zero, substantially equal to zero, less than zero and greater than zero in sequence.

The third preset condition may be that the bus current difference value may vary in a rule of being greater than zero, substantially equal to zero, and less than zero in sequence.

The fourth preset condition may be that the bus current difference value may vary in a rule of being greater than zero, substantially equal to zero, less than zero and greater than zero in sequence.

Compared to related art, the present disclosure may deliver the following advantages: through the disclosed brushless motor commutation control method in some embodiments, in response to detecting a failure of a back-EMF zero-crossing commutation, process a bus current value and a commutation time interval to generate processing information and determine whether the processing information may satisfy a preset condition. Control the motor to be forcedly commutated in response to satisfying a preset condition, so that the system may maintain continuous operation, enhance stability, and optimize user experience perception.

### BRIEF DESCRIPTION OF THE DRAWINGS

The specific embodiments of the present disclosure will be described in further detail below in conjunction with the accompanying drawings.

FIG. 1 is a flowchart illustrating steps of a brushless motor commutation control method according to some embodiments of the present disclosure.

FIG. 2 is a schematic structural diagram I illustrating a brushless motor commutation control system according to some embodiments of the present disclosure.

FIG. 3 is a schematic structural diagram II illustrating a brushless motor commutation control system according to some embodiments of the present disclosure.

FIG. 4 is a schematic waveform diagram illustrating a brushless motor commutation control system according to some embodiments of the present disclosure.

### DETAILED DESCRIPTION

To clarify the technical problem, solution, and advantages of the present disclosure, the followings may provide a detailed description with reference to the accompanying drawings and specific embodiments.

The embodiments and application scenarios of the commutation control method for a brushless motor under this disclosure may be elaborated below with reference to the drawings.

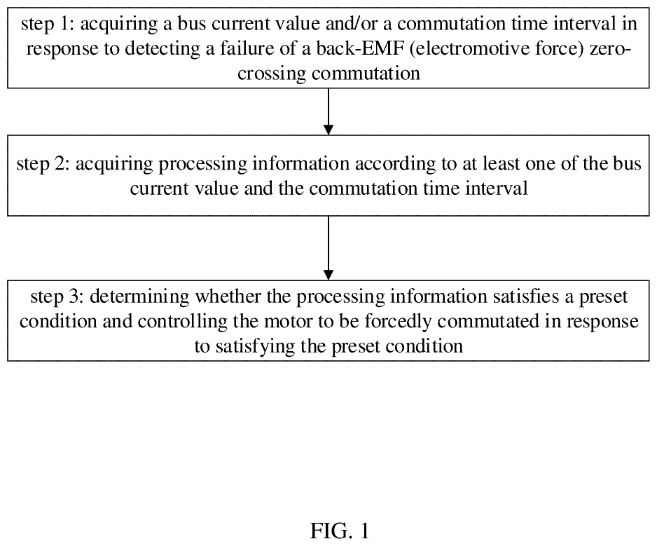

As shown in FIG. 1, a flowchart of the steps of a brushless motor commutation control method according to some embodiments of the present disclosure, the steps may include:
Step 1: acquiring a bus current value and/or a commutation time interval in response to detecting a failure of a back-EMF zero-crossing commutation.
Step 2: acquiring processing information according to the bus current value and/or the commutation time interval.
Step 3: determining whether the processing information may satisfy a preset condition and controlling the motor to be forcedly commutated in response to satisfying the preset condition.

### Embodiment 1

In response to detecting a failure of a back-EMF zero-crossing commutation, bus current values Iᵢ (0≤i≤X) may be acquired at K time points tᵢ (0≤i≤K), and a linear fitting may be performed on the bus current values to generate a corresponding curve slope value K, i.e., a bus current slope value.

In some embodiments, the first formula to acquire the bus current slope value K may be as follows:

$$K = ( {E}_{ti} - {E}_{t} \times {E}_{i} ) \div ( {E}_{t}^{2} - {( {E}_{t} )}^{2} )$$

In some embodiments, Eₜᵢ may denote the expectation value of the product of sampling time t and the bus current value, Eₜ may represent the mathematical expectation value of sampling time t, Eᵢ may signify the mathematical expectation value of the bus current value, Eₜ² may signify the mathematical expectation value of the squared sampling time t, and (Eₜ)² may be the square of the mathematical expectation value of sampling time t.

Furthermore, to enhance determination accuracy, a bus current filtering method may be incorporated. In this way, the bus current value Iᵢ(0≤i≤X) may be the value acquired after filtering. Thus, in response to employing a fixed-window filtering method, ΔTᵢ(0≤i≤X) may represent X bus current sampling intervals. For example, with sampling performed every 100 s and a preset X=8, a filtered value may be calculated every 800 μs, wherein ΔT₀=ΔT₁=ΔT₁=800 μs. And in response to using a sliding-window filtering method under identical preset condition, ΔT₀=ΔT₁=ΔTᵢ=100 u. In response to completion of either filtering process, the bus current slope value K may be calculated via Equation 1, representing the first derivative of the bus current value with respect to time.

In response to acquiring the bus current slope value from processing multiple bus current value, determine whether the bus current slope value may satisfy a preset condition. In response to satisfying, control the motor to be forcedly commutated.

In response to satisfying a preset condition, that is, in response to the bus current slope value satisfying a first preset condition, control the motor to be forcedly commutated; or in response to the bus current slope may satisfy a second preset condition, control the motor to be forcedly commutated. The first preset condition may be that the bus current slope value may vary in a rule of being greater than zero, substantially equal to zero, and less than zero in sequence. The second preset condition may be that the bus current slope value may vary in a rule of being greater than zero, substantially equal to zero, less than zero and greater than zero in sequence.

In response to employing the first preset condition for the motor to be forcedly commutated, the forced commutation time may closely align with the optimal or theoretical commutation point, achieving enhanced current and voltage waveform regulation while concurrently enhancing system continuity, stability, and user experience. In response to utilizing the second preset condition for the motor to be forcedly commutated, the forced commutation may be more reliable, which may reduce the occurrence of accidental triggering of forced commutation. At the same time, it may also enable the system to continue running, increase the stability of the system, and improve user experience.

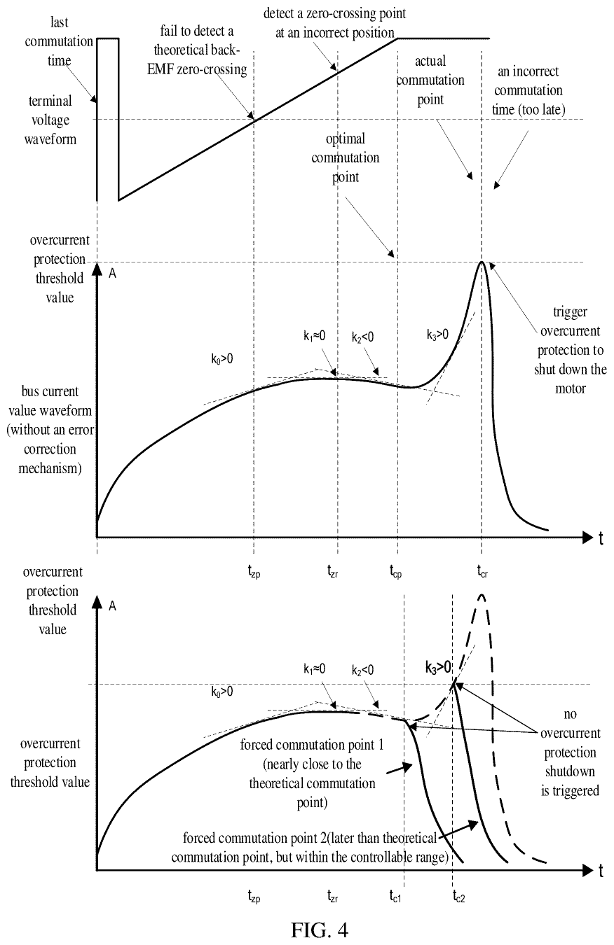

As shown in FIG. 4, the waveforms may include three groups: the top waveform group may indicate terminal voltage, the middle group may show an uncorrected bus current waveform, and the bottom group may display an error-corrected bus current waveform processed by the method in this disclosure.

Comparative analysis of these three groups waveforms may clearly demonstrate that the disclosed method may achieve the commutation time closely aligned with optimal or theoretical commutation points through error correction, thereby stabilizing current and voltage waveforms.

The bottom waveform in FIG. 4 may further illustrate the bus current slope value detection process: in response to the bus current slope value satisfying a preset condition, control the motor to be forcedly commutated.

In some embodiments, with reference to the processing procedure indicated by the blue trend line in the bottom waveform group of FIG. 4, forced commutation may be triggered in response to detecting that the bus current slope value may vary in a rule of being greater than zero, substantially equal to zero, and less than zero in sequence, that is, in response to the current slope waveform reaching the forced commutation point 1 as illustrated.

In some embodiments, with reference to the processing procedure indicated by the red trend line in the bottom waveform group of FIG. 4, forced commutation may be triggered in response to detecting that the bus current slope value may vary in a rule of being greater than zero, substantially equal to zero, less than zero, and greater than zero in sequence, that is, in response to the current slope waveform reaching the forced commutation point 2 as illustrated.

Correspondingly, the forced commutation point 2 may exhibit slight hysteresis relative to point 1, thus preventing false triggering and enhancing circuit fault tolerance.

The method provided in the present disclosure may be shown in FIG. 4. The waveform may be configured with two distinct forced commutation points, thereby improving the stability and compatibility of waveform control.

### Embodiment 2

In response to detecting a failure of a back-EMF zero-crossing commutation, bus current values Iᵢ(0≤i≤X) within X PWM cycles may be acquired, and a differential reduction algorithm may be performed on the bus current values to generate a corresponding bus current difference value C.

In some embodiments, the bus current slope value C is calculated using Equation 2:

Cᵢ=I₂ᵢ₊₁−I₂ᵢ, 0≤i≤X

After processing multiple bus current value to acquire the bus current difference value, determine whether the bus current difference value may satisfy a preset condition. In response to satisfying, control the motor to be forcedly commutated.

Satisfaction of a preset condition may be defined as: in response to the bus current slope value satisfying a third preset condition, control the motor to be forcedly commutated; or in response to the bus current slope value satisfying a fourth preset condition, control the motor to be forcedly commutated. The third preset condition may be that the bus current difference value may vary in a rule of being greater than zero, substantially equal to zero, and less than zero in sequence. The fourth preset condition may be that the bus current difference value may vary in a rule of being greater than zero, substantially equal to zero, less than zero and greater than zero in sequence.

In response to implementing forced commutation under the third preset condition, the forced commutation time may closely align with optimal or theoretical commutation points, achieving enhanced current and voltage waveform regulation while concurrently maintaining system operation, boosting stability, and improving user experience. In response to implementing forced commutation under the fourth preset condition, the forced commutation may be more reliable, which may reduce the occurrence of accidental triggering of forced commutation, enable the system to continue running, increase the stability of the system, and improve user experience.

### Embodiment 3

In response to detecting a failure of a back-EMF zero-crossing commutation, bus current values Iᵢ (0≤i≤X) may be acquired at K time points tᵢ (0≤i≤K), and a linear fitting may be performed on the bus current values to generate a corresponding curve slope value K, i.e., a bus current slope value.

In some embodiments, the first formula to acquire the bus current slope value K may be as follows:

$$K = ( {E}_{ti} - {E}_{t} \times {E}_{i} ) \div ( {E}_{t}^{2} - {( {E}_{t} )}^{2} )$$

In some embodiments, Eₜᵢ may denote the expectation value of the product of sampling time t and the bus current value, Eₜ may represent the mathematical expectation value of sampling time t, Eᵢ may signify the mathematical expectation value of the bus current value, Eₜ² may indicate the mathematical expectation value of squared sampling time t, and (Eₜ)² may be the square of the mathematical expectation value of sampling time t.

Concurrently, historical sector commutation time intervals may be acquired and they may be processed to generate a commutation time prediction value.

Simultaneously, the bus current instantaneous value may be detected within each PWM cycle in real-time.

After the acquired information being processed, determine whether the bus current slope value, the bus current instantaneous value and the commutation time prediction value may simultaneously satisfy a preset condition. In response to satisfying simultaneously, control the motor to be forcedly commutated.

Satisfaction of a preset condition may require the bus current slope value to satisfy a first preset condition, and the first preset condition may be that the bus current slope value may vary in a rule of being greater than zero, substantially equal to zero, and less than zero in sequence. Simultaneously, the commutation time may reach a commutation time prediction value and the bus current instantaneous value may reach a bus current instantaneous threshold value, and in response to such condition, control the motor to be forcedly commutated.

In response to controlling the motor to be forcedly commutated under the first preset condition, the forced commutation time may closely align with optimal or theoretical commutation points, achieving superior current and voltage waveform regulation. The addition of the bus current instantaneous threshold value and the commutation time prediction value as determination parameters may further ensure commutation stability in practical engineering applications, substantially enhancing the accuracy and reliability of forced commutation while concurrently maintaining system operation, boosting stability, and improving user experience.

Alternatively, satisfaction of a preset condition may require the bus current slope value to satisfy a second preset condition, and the second preset condition may be that the bus current slope value may vary in a rule of being greater than zero, substantially equal to zero, less than zero and greater than zero in sequence.

Simultaneously, the commutation time may reach the commutation time prediction value and the bus current instantaneous value reach the bus current instantaneous threshold value, and in response to such condition, control the motor to be forcedly commutated.

In response to controlling the motor to be forcedly commutated under the second preset condition, commutation reliability may increase significantly and the occurrence of accidental triggering of forced commutation may reduce. Incorporating the bus current instantaneous threshold value and the commutation time prediction value as determination parameters may guarantee the practical commutation stability, further optimizing forced commutation precision and dependability while similarly sustaining system continuity, enhancing stability, and elevating user experience.

### Embodiment 4

In response to detecting a failure of a back-EMF zero-crossing commutation, bus current values Iᵢ (0≤i≤X) may be acquired within X PWM cycles, and a differential reduction algorithm may be performed on the bus current values to generate a corresponding bus current difference value Cᵢ.

In some embodiments, the bus current difference value Cᵢ is defined by Equation 2:

Cᵢ=I₂ᵢ₊₁−I₂ᵢ, 0≤i≤X

Concurrently, historical sector commutation time intervals may be acquired and they may be processed to generate a commutation time prediction value.

Simultaneously, the bus current instantaneous value may be detected within each PWM cycle in real-time.

After the acquired information may be processed, determine whether the bus current difference value, the bus current instantaneous value, and the commutation time prediction value may simultaneously satisfy a preset condition. In response to satisfying simultaneously, control the motor to be forcedly commutated.

Satisfaction of a preset condition may require the bus current difference value to satisfy a third preset condition, and the third preset condition may be that the bus current difference value may vary in a rule of being greater than zero, substantially equal to zero, and less than zero in sequence. Meanwhile, the commutation time may reach a commutation time prediction value, and at the same time, the bus current instantaneous value may reach a bus current instantaneous threshold value. In response to such condition, control the motor to be forcedly commutated.

In response to controlling the motor to be forcedly commutated under the third preset condition, the forced commutation time may closely align with optimal or theoretical commutation points, resulting in well-controlled current and voltage waveforms. Incorporating the bus current instantaneous threshold value and the predicted commutation time point as determination parameters may further enhance commutation stability in practical engineering applications, significantly improving the accuracy and reliability of forced commutation; simultaneously, this approach may enable continued system operation, strengthen system stability, and elevate user experience.

Alternatively, satisfaction of a preset condition may require the bus current difference value to satisfy a fourth preset condition, and the fourth preset condition may be that the bus current difference value may vary in a rule of being greater than zero, substantially equal to zero, less than zero and greater than zero in sequence. Simultaneously, in response to the commutation time reaching the commutation time prediction value and the bus current instantaneous value reaching the bus current instantaneous threshold value, control the motor to be forcedly commutated.

In response to controlling the motor to be forcedly commutated under the fourth preset condition, the forced commutation may become more reliable and triggering falsely may be prevented. Incorporating the bus current instantaneous threshold value and the predicted commutation time point as determination parameters may further enhance commutation stability in practical engineering applications, significantly improving the accuracy and reliability of forced commutation. Simultaneously, this approach may enable continued system operation, strengthen system stability, and elevate user experience.

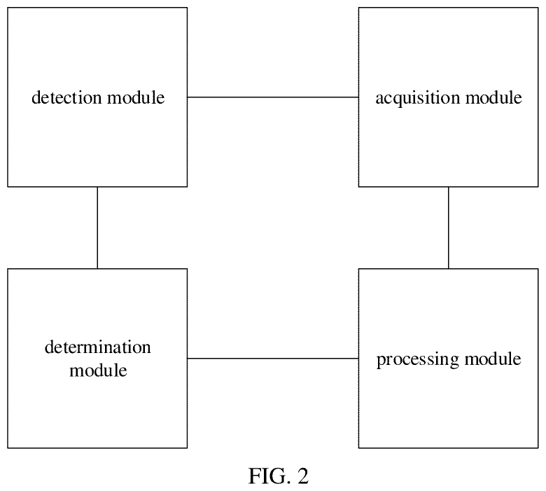

As shown in FIG. 2, a structural diagram I of a brushless motor commutation control system according to some embodiments of the present disclosure, the commutation control system for a brushless motor may include a detection module, an acquisition module, a processing module, and a determination module. The detection module may be configured to detect a back-EMF zero-crossing point for driving commutation. The acquisition module may be configured to acquire a bus current value and/or a commutation time interval in response to a detection module failure. The processing module may be configured to process the bus current value and/or the commutation time interval to generate a processing information. The determination module may be configured to determine whether the processing information may satisfy a preset condition and control the moto to be forcedly commutated in response to satisfying the preset condition.

The aforementioned brushless motor commutation system may apply the aforementioned brushless motor commutation control method, with specific determination procedures referencing Embodiments 1 to 4 described above.

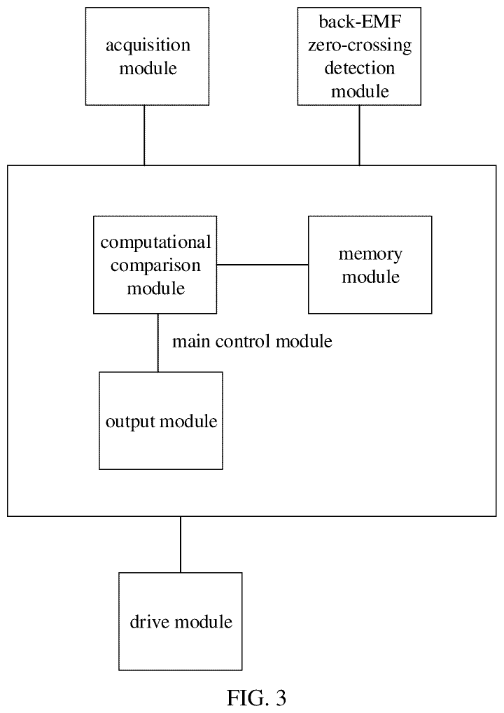

As shown in FIG. 3, a schematic diagram of a brushless motor commutation control system according to some embodiments of the present disclosure, the commutation control system may include: an acquisition module, a back-EMF zero-crossing detection module, a main control module and a drive module. The acquisition module may be configured to acquire a bus current value and/or a sector time interval. The back-EMF zero-crossing detection module, electrically connected to the main control module, may be configured to detect a back-EMF zero-crossing point of the motor and output a first signal to the main control module according to the zero-crossing point. The main control module, electrically connected to the drive module and the acquisition module respectively, may include a signal output module. The signal output module may be configured to receive the first signal and outputting a commutation signal to the drive module. The drive module may be configured to drive the motor to be commutated according to the commutation signal. The main control module may also include a computational comparison module, a memory module, and an output module. The computational comparison module may be configured to receive the bus current and/or the sector time interval to generate a processing information and the main control module may compare the processing information against a preset condition stored in the memory module. The memory module may store a current threshold value and the preset condition. In response to failing to receive the first signal, the main control module may determine whether the processing information may satisfy the preset condition and the output module may emit the commutation signal in response to satisfying.

The aforementioned brushless motor commutation system may apply the aforementioned brushless motor commutation control method, with specific determination procedures referencing Embodiments 1 to 4 described above.

In some embodiments of the present disclosure, a brushless motor commutation control system, including a memorizer and a processor, may be provided. In some embodiments, the memorizer may store a computer program executable by the processor, and the execution of the computer program by the processor may implement the method described above.

Additionally, in some embodiments of the present disclosure, a non-transitory computer-readable medium may be provided. The non-transitory computer-readable medium may embody a non-volatile program code that the processor may execute. The non-volatile program code may enable the processor to execute the aforementioned method.

It is to be understood that in this document, the terms “including”, “comprising”, or any variations thereof may be intended to cover a non-exclusive inclusion. Thus, a process, method, article, or device that may include a list of elements not only include those elements, but may also include other elements not expressly listed or elements inherent to such process, method, article, or device. Absent further limitations, an element defined by the phrase “including a . . . ” may not preclude the existence of additional identical elements in the process, method, article, or device that may include the elements.

The foregoing may describe preferred embodiments of the present disclosure. It should be noted that those skilled in the art may well make several refinements and modifications without departing from the principles of the disclosure disclosed herein. Such refinements and modifications shall also fall within the protection scope of the present disclosure.

1. A commutation control method for a brushless motor, comprising:
step 1: acquiring at least one of a bus current value and a commutation time interval in response to detecting a failure of a back-EMF (electromotive force) zero-crossing commutation;
step 2: acquiring processing information according to at least one of the bus current value and the commutation time interval;
step 3: determining whether the processing information satisfies a preset condition; and then controlling the motor to be forcedly commutated in response to satisfying the preset condition.

2. The commutation control method as claimed in claim 1, wherein the processing information comprises a bus current slope value, and the step 3 comprises:
controlling the motor to be forcedly commutated in response to the bus current slope value satisfying a first preset condition; or
controlling the motor to be forcedly commutated in response to the bus current slope value satisfying a second preset condition;
wherein the first preset condition is that the bus current slope value varies in a rule of being greater than zero, substantially equal to zero, and less than zero in sequence;
and wherein the second preset condition is that the bus current slope value varies in a rule of being greater than zero, substantially equal to zero, less than zero and greater than zero in sequence.

3. The commutation control method as claimed in claim 1, wherein the processing information comprises a bus current difference value, and the step 3 comprises:
controlling the motor to be forcedly commutated in response to the bus current difference value satisfying a third preset condition; or
controlling the motor to be forcedly commutated in response to the bus current difference value satisfying a fourth preset condition;
wherein the third preset condition is that the bus current difference value varies in a rule of being greater than zero, substantially equal to zero, and less than zero in sequence; and wherein the fourth preset condition is that the bus current difference value varies in a rule of being greater than zero, substantially equal to zero, less than zero and greater than zero in sequence.

4. The commutation control method as claimed in claim 1, wherein the processing information comprises a bus current slope value, a bus current instantaneous value, and a commutation time prediction value, and the step 3 comprises:
controlling the motor to be forcedly commutated in response to the bus current slope value satisfying a first preset condition and the bus current instantaneous value satisfying a threshold condition, and the commutation time prediction value satisfying a time condition; or
controlling the motor to be forcedly commutated in response to the bus current slope value satisfying a second preset condition and the bus current instantaneous value satisfying a threshold condition, and the commutation time prediction value satisfying a time condition;
wherein the first preset condition is that the bus current slope value varies in a rule of being greater than zero, substantially equal to zero, and less than zero in sequence;
and wherein the second preset condition is that the bus current slope value varies in a rule of being greater than zero, substantially equal to zero, less than zero and greater than zero in sequence.

5. The commutation control method as claimed in claim 1, wherein the processing information comprises a bus current difference value, a bus current instantaneous value, and a commutation time prediction value, and the step 3 comprises:
controlling the motor to be forcedly commutated in response to the bus current difference value satisfying a third preset condition, the bus current instantaneous value satisfying a threshold condition and the commutation time prediction value satisfying a time condition; or
controlling the motor to be forcedly commutated in response to the bus current difference value satisfying a fourth preset condition, the bus current instantaneous value satisfying a threshold condition and the commutation time prediction value satisfying a time condition;
wherein the third preset condition is that the bus current difference value varies in a rule of being greater than zero, substantially equal to zero, and less than zero in sequence; and wherein the fourth preset condition is that the bus current difference value varies in a rule of being greater than zero, substantially equal to zero, less than zero and greater than zero in sequence.

6. (canceled)

7. (canceled)

8. (canceled)

9. A commutation control system for a brushless motor, comprising a memorizer and a processor, wherein the memorizer stores a computer program executable by the processor, and the processor executes the program to implement the method which comprises:
step 1: acquiring at least one of a bus current value and a commutation time interval in response to detecting a failure of a back-EMF (electromotive force) zero-crossing commutation;
step 2: acquiring processing information according to at least one of the bus current value and the commutation time interval;
step 3: determining whether the processing information satisfies a preset condition and controlling the motor to be forcedly commutated in response to satisfying the preset condition.

10. A non-transitory computer-readable medium, embodying a non-volatile program code executable by the processor, wherein the program code causes the processor to execute the method which comprises:
step 1: acquiring at least one of a bus current value and a commutation time interval in response to detecting a failure of a back-EMF (electromotive force) zero-crossing commutation;
step 2: acquiring processing information according to at least one of the bus current value and the commutation time interval;
step 3: determining whether the processing information satisfies a preset condition and controlling the motor to be forcedly commutated in response to satisfying the preset condition.

11. The commutation control method as claimed in claim 2, wherein the bus current slope value is calculated by a formula as follows:
$$K = ( {E}_{ti} - {E}_{t} \times {E}_{i} ) \div ( {E}_{t}^{2} - {( {E}_{t} )}^{2} )$$
wherein Eₜᵢ denotes the expectation of the product of sampling time t and the bus current value i, Eₜ represents the mathematical expectation value of sampling time t, Eᵢ signifies the mathematical expectation value of the bus current value i, Eₜ² indicates the mathematical expectation value of squared sampling time t, and (Eₜ)² is the square of the mathematical expectation value of sampling time t.

12. The commutation control method as claimed in claim 3, wherein the bus current difference value is calculated by a formula as follows:
Cᵢ=I₂ᵢ₊₁−I₂ᵢ, 0≤i≤X
wherein I₂ᵢ₊₁ and I₂ᵢ represent bus current instantaneous values at different time.

13. The commutation control method as claimed in claim 4, wherein the commutation time prediction value is acquired by processing a sector time interval.

14. The commutation control method as claimed in claim 4, wherein the bus current instantaneous value is a real-time value detected within each PWM cycle.

15. The commutation control method as claimed in claim 1, wherein the bus current value comprises values after filtering process.

16. The commutation control method as claimed in claim 15, wherein the filtering process comprise:
a fixed-window filtering or a sliding-window filtering.

17. The commutation control method as claimed in claim 4, wherein the threshold condition is that the bus current instantaneous value reaches a preset bus current instantaneous threshold value.

18. The commutation control method as claimed in claim 4, wherein the time condition is that the commutation time reaches a commutation time prediction value.

19. The commutation control system as claimed in claim 9, wherein the processing information comprises a bus current slope value, and the step 3 comprises:
controlling the motor to be forcedly commutated in response to the bus current slope value satisfying a first preset condition; or
controlling the motor to be forcedly commutated in response to the bus current slope value satisfying a second preset condition;
wherein the first preset condition is that the bus current slope value varies in a rule of being greater than zero, substantially equal to zero, and less than zero in sequence;
and wherein the second preset condition is that the bus current slope value varies in a rule of being greater than zero, substantially equal to zero, less than zero and greater than zero in sequence.

20. The commutation control system as claimed in claim 9, wherein the processing information comprises a bus current difference value, and the step 3 comprises:
controlling the motor to be forcedly commutated in response to the bus current difference value satisfying a third preset condition; or
controlling the motor to be forcedly commutated in response to the bus current difference value satisfying a fourth preset condition;
wherein the third preset condition is that the bus current difference value varies in a rule of being greater than zero, substantially equal to zero, and less than zero in sequence; and wherein the fourth preset condition is that the bus current difference value varies in a rule of being greater than zero, substantially equal to zero, less than zero and greater than zero in sequence.

21. The commutation control system as claimed in claim 9, wherein the processing information comprises a bus current slope value, a bus current instantaneous value, and a commutation time prediction value, and the step 3 comprises:
controlling the motor to be forcedly commutated in response to the bus current slope value satisfying a first preset condition and the bus current instantaneous value satisfying a threshold condition, and the commutation time prediction value satisfying a time condition; or
controlling the motor to be forcedly commutated in response to the bus current slope value satisfying a second preset condition and the bus current instantaneous value satisfying a threshold condition, and the commutation time prediction value satisfying a time condition;
wherein the first preset condition is that the bus current slope value varies in a rule of being greater than zero, substantially equal to zero, and less than zero in sequence;
and wherein the second preset condition is that the bus current slope value varies in a rule of being greater than zero, substantially equal to zero, less than zero and greater than zero in sequence.

22. The commutation control system as claimed in claim 9, wherein the processing information comprises a bus current difference value, a bus current instantaneous value, and a commutation time prediction value, and the step 3 comprises:
controlling the motor to be forcedly commutated in response to the bus current difference value satisfying a third preset condition, the bus current instantaneous value satisfying a threshold condition and the commutation time prediction value satisfying a time condition; or
controlling the motor to be forcedly commutated in response to the bus current difference value satisfying a fourth preset condition, the bus current instantaneous value satisfying a threshold condition and the commutation time prediction value satisfying a time condition;
wherein the third preset condition is that the bus current difference value varies in a rule of being greater than zero, substantially equal to zero, and less than zero in sequence; and wherein the fourth preset condition is that the bus current difference value varies in a rule of being greater than zero, substantially equal to zero, less than zero and greater than zero in sequence.

23. The non-transitory computer-readable medium as claimed in claim 10, wherein the processing information comprises a bus current slope value, a bus current difference value, a bus current instantaneous value and a commutation time prediction value.
